(19) United States
(12) Patent Application Publication
(10) Pub. No.: US 2015/0369629 A1
(43) Pub. Date: Dec. 24, 2015

(54) Angle Sensor

(71) Applicant: Ninebot(Tianjin) Technology Co., Ltd., Tianjin (CN)

(72) Inventors: Zhongyuan Chen, Tianjin (CN); Ye Wang, Tianjin (CN); Xudong Jiang, Tianjin (CN)

(21) Appl. No.: 14/547,067

(22) Filed: Nov. 18, 2014

(30) Foreign Application Priority Data
Jun. 24, 2014 (CN) 201420343523.1

(51) Int. Cl. G01D 5/14

(52) U.S. Cl. CPC G01D 5/142

(57) ABSTRACT

An angle sensor, which relates to a technical field of angle measurement, includes: a Hall component and a magnet provided on a fixing frame; wherein the Hall component serves as a rotor, and the magnet serves as a stator; or, the Hall component serves as a stator, and the magnet serves as a rotor. The rotor is connected with a steering mechanism, and the Hall component generates and outputs a Hall voltage, so as to determine the steering angle of the steering mechanism based on the Hall voltage. Driven by the steering mechanism, a magnetic field of the magnet rotates accordingly, or the Hall component rotates accordingly, causing a result that a magnetic field applied to the Hall component changes, and ultimately leading to a change of the Hall voltage outputted by the Hall component, so as to obtain the steering angle of the steering mechanism.

### CROSS REFERENCE OF RELATED APPLICATION

The present invention claims priority under 35 U.S.C. 119(a-d) to CN 201420343523.1, filed Jun. 24, 2014.

### BACKGROUND OF THE PRESENT INVENTION

1. Field of Invention

The present invention relates to the technical field of an angle measurement, and more particularly to an angle sensor.

2. Description of Related Arts

Electric balance vehicle or Motor balance vehicle is an advanced short distance vehicle, such as the Ninebot series of self-balance scooter robots on current market, wherein using electricity as power, the posture and condition of the vehicle is sensed through an attitude measurement sensor consisting of a built-in microcomputer gyroscope and an accelerometer, and control commands are computed through a high-speed processor to drive the motor and move the vehicle.

Conventionally the steering function of the balance vehicle relies mainly on a potentiometer, which monitors changes of currents and controls steering of the vehicle. FIG. 1 is a sketch view of a conventional potentiometer used for a steering function. As shown in FIG. 1, the potentiometer has three terminals ABC, a rotary shaft 101, a resistor 102 and a brush 103. During the process of steering, the brush 103 moves along the resistor 102, thus resistance change and current change corresponding to the amount of displacement are obtained, so as to control the steering angle of the balance vehicle accordingly. However, in order to control the steering angle, the potentiometer relies directly on the current change caused by the movement of the brush 103 along the resistor 102, so mechanical contacts between the brush 102 and the resistor 103 are inevitable. Therefore, mechanical wear exists, resulting in a short service life of the potentiometer and poor stability of the steering control.

### SUMMARY OF THE PRESENT INVENTION

The present invention provides an angle sensor to solve the technical problems in the prior art, such as a short service life of the potentiometer and poor stability of steering control, and etc.

In order to solve the technical problems mentioned above, the present invention provides an angle sensor comprising a Hall component and a magnet provided on a fixing frame, wherein the Hall component serves as a stator and the magnet serves as a rotor. The rotor is connected with a steering mechanism, in such a manner that the magnet is driven by the steering mechanism to rotate, so as to generate and output a Hall voltage, and determine a steering angle of the steering mechanism based on the Hall voltage.

In order to solve the technical problems mentioned above, the present invention provides another angle sensor, comprising a Hall component welded to a PCB board and a magnet provided on a fixing frame, wherein the Hall component serves as a rotor and the magnet serves as a stator; the rotor is connected with the steering mechanism, in such a manner that the magnet is driven by the steering mechanism to rotated, so as to generate and output a Hall voltage and determine the steering angle of the steering mechanism based on the Hall voltage.

Preferably, according to a preferred embodiment of the present invention, the fixing frame is a stop block.

Preferably, according to another preferred embodiment of the present invention, the fixing frame is made of non-metallic materials.

Preferably, according to another preferred embodiment of the present invention, the angle sensor further comprises a protective cover to protect and position the Hall component.

Preferably, according to another preferred embodiment of the present invention, the protective cover is made of non-metallic materials.

Compared with the conventional technical solutions, driven by the steering mechanism, a magnetic field of the magnet rotates accordingly, or the Hall component rotates accordingly, causing a result that a magnetic field applied to the Hall component changes, and ultimately leading to a change of the Hall voltage outputted by the Hall component, so as to obtain the steering angle of the steering mechanism. Therefore, during the magnet rotation process driven by the steering mechanism, the magnet is not mechanically contacted with the Hall component, which avoids wear of the potentiometer in the conventional art and further improves stability of the angle sensor.

### BRIEF DESCRIPTION OF THE DRAWINGS

FIG. 1 is a sketch view of a conventional potentiometer for a steering function.

FIG. 2 is a sketch view of an angle sensor according to a first preferred embodiment of the present invention.

FIG. 3 is a sketch view of the angle sensor according to a second preferred embodiment of the present invention.

FIG. 4 is a sketch view of the angle sensor according to another preferred embodiment of the present invention.

FIG. 5 is a sketch view of the angle sensor according to another preferred embodiment of the present invention.

### DETAILED DESCRIPTION OF THE PREFERRED EMBODIMENT

These and other objectives, features, and advantages of the present invention will become apparent from the following detailed description, the accompanying drawings, and the appended claims.

One skilled in the art will understand that the embodiment of the present invention as shown in the drawings and described above is exemplary only and not intended to be limiting.

According to a preferred embodiment of the present invention, driven by a steering mechanism, a magnetic field of a magnet rotates accordingly, or a Hall component rotates accordingly, causing a result that the magnetic field applied to the Hall component changes, and ultimately leading to a change of a Hall voltage outputted by the Hall component, so as to obtain a steering angle of the steering mechanism. Therefore, during a magnet rotation process driven by the steering mechanism, the magnet is not mechanically contacted with the Hall component, and thus potentiometer wear in the conventional art is avoided and stability of an angle sensor is further improved.

### The Core Ideas of the Present Invention

The core idea of the angle sensor provided in the following preferred embodiments of the present invention comprises: a Hall component and a magnet provided on a fixing frame 105;

wherein the Hall component serves as a rotor and the magnet serves as a stator; alternatively, the Hall component serves as a stator and the magnet serves as a rotor;

wherein the rotor is connected with a steering mechanism, and the Hall component generates and outputs a Hall voltage, so as to determine the steering angle of the steering mechanism based on the Hall voltage.

In the following preferred embodiments, the Hall component serves as the rotor and the magnet serves as the stator, so as to illustrate the angle sensor in this application. It should be noted that inspired by the following preferred embodiments in this application, technicians in the art can realize the core ideas of this application without creative work by utilizing the Hall component for serving as the rotor and the magnet for serving as the stator.

FIG. 2 is a sketch view of the angle sensor according to a first preferred embodiment of the present invention. As is shown in FIG. 2, a Hall component 102 is provided in a magnetic field created by two magnets 101. The Hall component 102 serves as a stator and the magnets 101 serve as a rotor; or, the magnets 101 serve as a stator and the Hall component serves 102 as a rotor. In both cases, the Hall component 102 outputs a Hall voltage.

Specifically, the two magnets 101 are respectively provided right above and below the hall component 102 to create the magnetic field, so as to generate the Hall voltage. The magnets 101 serve as a rotor and rotate in accordance with the steering mechanism. In one preferred embodiment, the magnets 101 and the Hall component 102 are in vertically alignment, in such a manner that the Hall component 102 is at a center of the magnetic field created by the magnets 101.

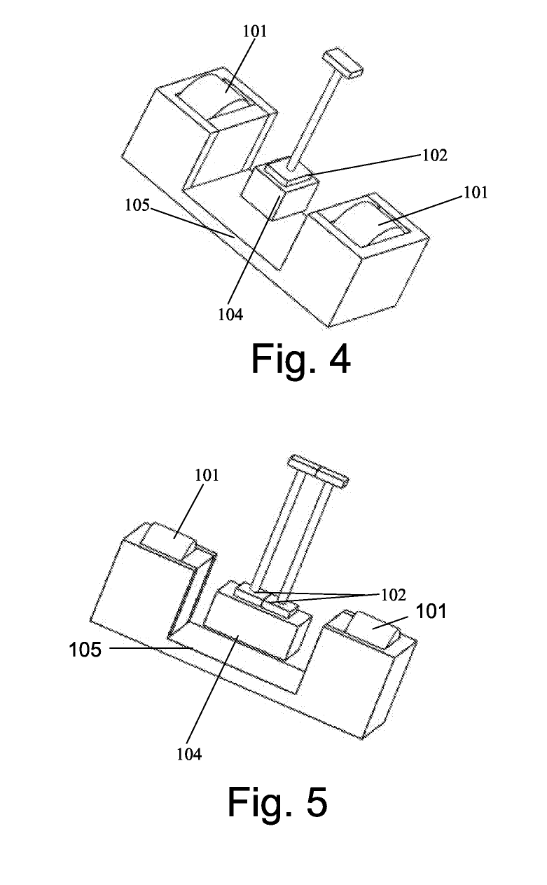

Referring to FIGS. 4-5, according to another preferred embodiment of the present invention, the Hall component 102 and magnets 101 are not aligned vertically, i.e., biased in position. In order to facilitate fixation of the magnets 101, the magnets 101 are mounted on a fixing frame 105, and the fixing frame 105 is connected with an external steering mechanism. The fixing frame 105 is embodied as a stop block, and the magnets 101 are provided therein. In order to reduce weight and avoid electromagnetic interference, the stop block is preferably made of non-metallic materials.

It is worth mentioning that in practical implementation, the two magnets 101 and the Hall component 102 are not specially defined. For example, the Hall component 102 is directly welded to a PCB board, and the magnets 101 are mounted on the steering mechanism of the balance vehicle; or, the magnets 101 are directly welded to a PCB board, and the Hall component 102 is mounted on the steering mechanism of the balance vehicle; and the rotor is driven by the steering mechanism to rotate.

The Hall component 102 measures changes of the Hall voltage and further changes of current which are caused by the changes in the magnetic field during steering.

It is worth mentioning that, referring to FIGS. 4-5, according to another preferred embodiment of the present invention in order to protect and position the Hall component, a protective cover 104. is provided outside the Hall component. The fixing position between the protective cover 104 and the Hall component is not specially defined. In order to reduce weight and avoid electromagnetic interference, the protective cover 104 is preferably made of non-metallic materials.

It is worth mentioning that in the first preferred embodiment shown in FIG. 2, driven by the steering mechanism, the magnets 101 rotate around the Hall component 102, so as to change strength of the magnetic field applied to Hall element 102 to obtain corresponding change in the Hall voltage, and accordingly obtain the steering angle of the steering mechanism.

It is worth mentioning that a specific relationship between change of the Hall voltage and the steering angle is related to specifications of the Hall component, and property parameters of the magnet, e.g, in a specific implementation embodiment, the relation between the change of the Hall voltage and the steering mechanism is:

Uout=Uo+Aθ(−180°≦θ≦180°),

wherein Uout is a real-time output voltage of the Hall component; Uo is an output voltage of the Hall component in an initial position; A is a correlation coefficient between the Hall component and the magnetic field.

It is worth mentioning that in the formula mentioned above, Uo may not be completely fixed, which is related to specific design of actual products.

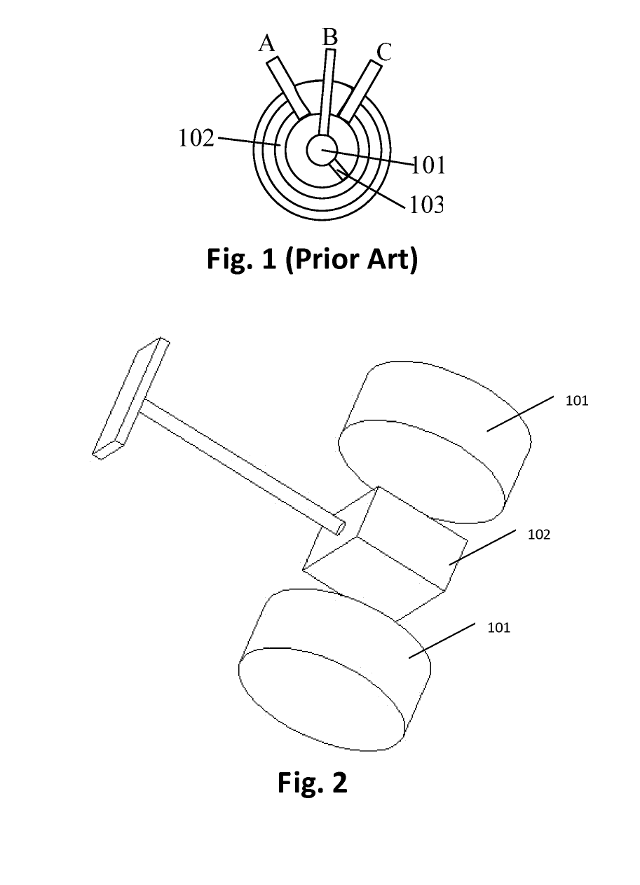

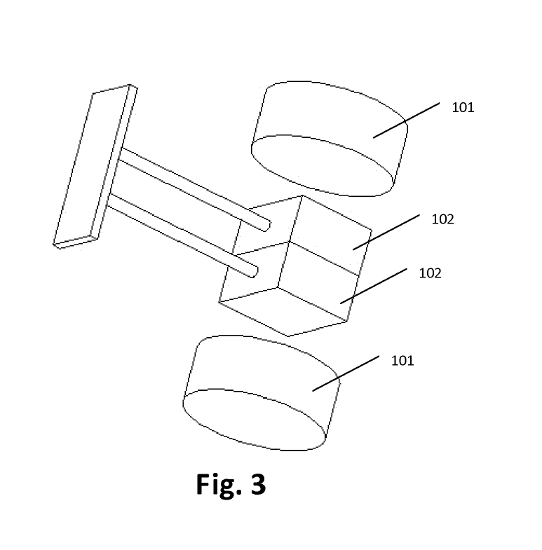

FIG. 3 is a sketch view of the angle sensor according to a second preferred embodiment of the present invention. As shown in FIG. 3, “redundancy”, i.e., countermeasures when the Hall component fails, is taken into account. Different from the first preferred embodiment shown in FIG. 1, in the second preferred embodiment, at least two Hall components 102 are provided in the same magnetic field created by the two magnets 101, and one of the Hall components 102 is a spare. The two Hall components 101 can be vertically aligned.

When the Hall components 102 serve as a stator, the magnets 101 serve as a rotor; alternatively, when the magnets 101 serve as the stator and the Hall component 102 serve as a rotor. In both cases, the Hall components 102 output the Hall voltage.

It is worth mentioning that in the second preferred embodiment, the two Hall components 102 share the same magnetic field. According to another preferred embodiment, each one of the Hall components 102 is respectively provided in a magnetic field. The details are omitted.

Next, a brief description about principle of switching between the two Hall components 102 in FIG. 2 is as follows, which can be realized in accordance with descriptions of the preferred embodiment in the present application by ordinary technicians in the art without any creative labor.

A controller receives and monitors the output voltage of the currently working Hall components 102. If the controller determines that the output voltage exceeds a preset normal range, e.g., the output voltage is at 0V, or greater than or equal to 5V, the result indicates that the Hall components 102 have a fault and are not capable of working normally. Therefore, a main controller stops receiving signals from the Hall component which gives abnormal output voltage, and starts to receive an output voltage output by the other Hall component; the steering angle is calculated accordingly. Besides, the controller can also send a voice or light alarm to warn customers to replace the Hall component.

The above description illustrates certain preferred embodiments of the present invention, but as previously said, it should be understood that the use of the present invention is not limited to the examples given herein and other preferred embodiments should not be excluded. It can be used in various other combinations, modifications, and environments, and within the outline given by this present invention. Variations can be made in accordance with the above guidelines and related knowledge or technology in the related arts. Therefore, this invention includes all modifications encompassed within the spirit and scope of the following claims.

What is claimed is:

1. An angle sensor, comprising a Hall component and a magnet provided on a fixing frame;
wherein the Hall component serves as a rotor and the magnet serves as a stator;
the rotor is connected with a steering mechanism and driven by the steering mechanism to rotate, in such a manner that the Hall component generates and outputs a Hall voltage, so as to determine a steering angle of the steering mechanism according to the Hall voltage.

2. The angle sensor, as recited in claim 1, wherein the fixing frame is a stop block.

3. The angle sensor, as recited in claim 1, wherein the fixing frame is made of non-metallic materials.

4. The angle sensor, as recited in claim 1, further comprising a protective cover for protecting and positioning the Hall component.

5. The angle sensor, as recited in claim 4, wherein the protective cover is made of non-metallic materials.

6. An angle sensor, comprising a Hall component welded on a PCB board and a magnet provided on a fixing frame;
wherein the Hall component serves as a rotor and the magnet serves as a stator;
the rotor is connected with a steering mechanism and driven by the steering mechanism to rotate, in such a manner that the Hall component generates and outputs a Hall voltage, so as to determine a steering angle of the steering mechanism according to the Hall voltage.

7. The angle sensor, as recited in claim 6, wherein the fixing frame is a stop block.

8. The angle sensor, as recited in claim 6, wherein the fixing frame is made of non-metallic materials.

9. The angle sensor, as recited in claim 6, further comprising a protective cover for protecting and positioning the Hall component.

10. The angle sensor, as recited in claim 9, wherein the protective cover is made of non-metallic materials.
